(19) United States
(12) Patent Application Publication
(10) Pub. No.: US 2010/0295313 A1
(43) Pub. Date: Nov. 25, 2010

(54) RUN-OF-RIVER HYDROELECTRIC POWER GENERATION APPARATUS

(75) Inventor: Shih-Hsiung CHEN, Yongkang City (TW)

Correspondence Address: HDLS IPR Services, PO Box 220746, Chantilly, VA, 20153, US

(73) Assignee: Thermaflow Energy Technoloby, Inc.

(21) Appl. No.: 12/718,426

(22) Filed: Mar. 5, 2010

(30) Foreign Application Priority Data
May 22, 2009 (TW) 098208987

(51) Int. Cl. F03B 13/00

(52) U.S. Cl. 290/54

(57) ABSTRACT

A hydroelectric power generation apparatus includes a buoy having a buoyancy for floating on a water surface, an electric generator including a rotating shaft installed at a top surface of the buoy, a hollow case tapered from both ends towards the center of the case, and a side of the case being coupled to the bottom of the buoy and a vane wheel installed at the bottom of the buoy and including a wheel shaft and a plurality of vanes installed in the case, and a transmission belt installed around both wheel shaft and rotating shaft for providing a transmission between the wheel shaft and the rotating shaft, such that when the water current flows through the vanes to drive the wheel shaft to rotate, the transmission of the transmission belt drives the rotating shaft of the electric generator to rotate, so as to generate electric energy.

### FIELD OF THE INVENTION

The present invention generally relates to hydroelectric power generation, in particular to a run-of-water hydroelectric power generation apparatus.

### BACKGROUND OF THE INVENTION

Hydroelectric power generation is a way of generating electric power by converting potential energy and kinetic energy of water into electric energy. At present, there are different methods of achieving the hydroelectric power generation, and one of the methods is to construct a dam and install a hydroelectric generator for the electric power generation. However, this method incurs unusually high expenses for the construction of the dam, and the dam also damages the natural landscape and ecology, and thus less and less dams are built now. Another method is to build a pumped-storage hydroelectric plant including two water storage pools built at upstream and downstream locations of a river respectively. During off-peak hours, water is pumped from the downstream water pool to the upstream water pool for the recycle and reuse of the water. However, the expense required for building such hydroelectric power generation plant is very high. Another famous hydroelectric power generation method is to build a large underwater turbine at a riverbed, such as the underwater turbine built at the East Water in New York of the United States, and tides are used for driving the turbine to rotate. However, the construction of the underwater turbine at the waterbed incurs tremendous efforts and high costs, which are not cost-effective, and the operation of the turbine at the waterbed not only gives rise to a high level of difficulty for the maintenance, but it also has a safety concern.

It is a main subject of the present invention to use the plentiful water source to build an easy-to-install, low-cost and safe hydroelectric power generation apparatus.

### SUMMARY OF THE INVENTION

Therefore, it is a primary objective of the present invention to provide a run-of-water hydroelectric power generation apparatus that can be installed separately at many locations of a river. The apparatus not only has the advantages of a simple construction and a low cost only, but also provides an easy installation.

Another objective of the present invention is to provide a run-of-water hydroelectric power generation apparatus that can be installed at a corner of a river without hindering the routes of boats, and the electric generator is installed at a water surface, and thus the apparatus provides a safe operation and an easy maintenance.

To achieve the foregoing objectives, the present invention discloses a run-of-water hydroelectric power generation apparatus applied to a river having a water current, and the apparatus comprises a buoy, an electric generator, a case, a vane wheel and a transmission belt, wherein the buoy has a buoyancy for floating on a water surface of the river, and the electric generator includes a rotating shaft installed at a top surface of the buoy, and the case is a hollow case tapered from both ends to the center of the case to form an expanded open shape at both ends of the case, and a side of the case is connected to a bottom surface of the buoy, and the vane wheel includes a wheel shaft installed in the case, a plurality of vanes installed at a side of the wheel shaft, and a fixed stand coupled to another side of the wheel shaft and also coupled to an internal wall of the case, and a transmission belt is installed around the wheel shaft and the rotating shaft and provided for a transmission of the wheel shaft and the rotating shaft.

Compared with the prior art, the present invention uses a buoy, an electric generator, a case, a vane wheel and a transmission belt to build a simple-structured run-of-water hydroelectric power generation apparatus that incurs a low cost and provides an easy installation. The invention not just waives the complicated construction and the huge installation space and allows the apparatuses to be installed at different locations of a river without hindering the routes of the boats, but also allows the electric generator to be installed at the water surface to achieve the effects of safe operation and easy maintenance.

To make it easier for the examiner to understand the objects, characteristics and effects of this invention, we use preferred embodiments together with the attached drawings for the detailed description of the invention.

### BRIEF DESCRIPTION OF THE DRAWINGS

FIG. 1 is a perspective view of a run-of-water hydroelectric power generation apparatus in accordance with present invention;

FIG. 2 is a side view of a run-of-water hydroelectric power generation apparatus in accordance with present invention;

FIG. 3 is a schematic view of using a run-of-water hydroelectric power generation apparatus in accordance with present invention; and

FIG. 4 is a schematic view of an application of a run-of-water hydroelectric power generation apparatus in accordance with present invention.

### DESCRIPTION OF THE PREFERRED EMBODIMENTS

The technical characteristics and contents of the present invention will become apparent with the following detailed description accompanied with related drawings.

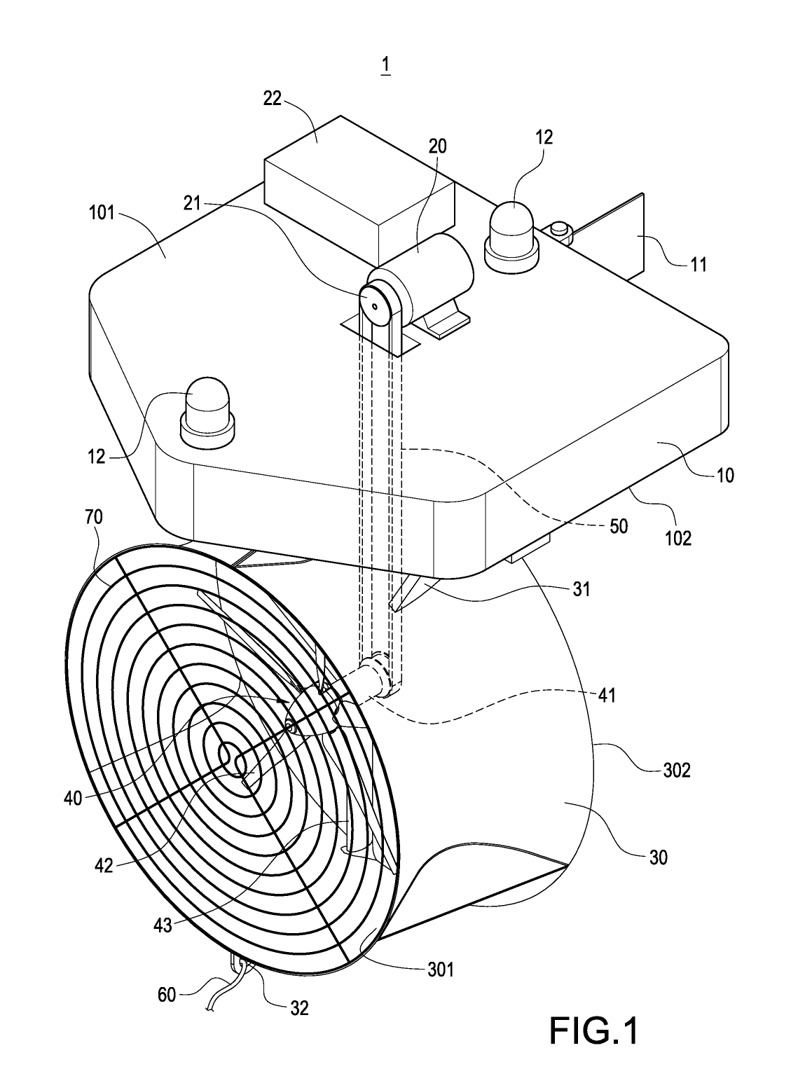

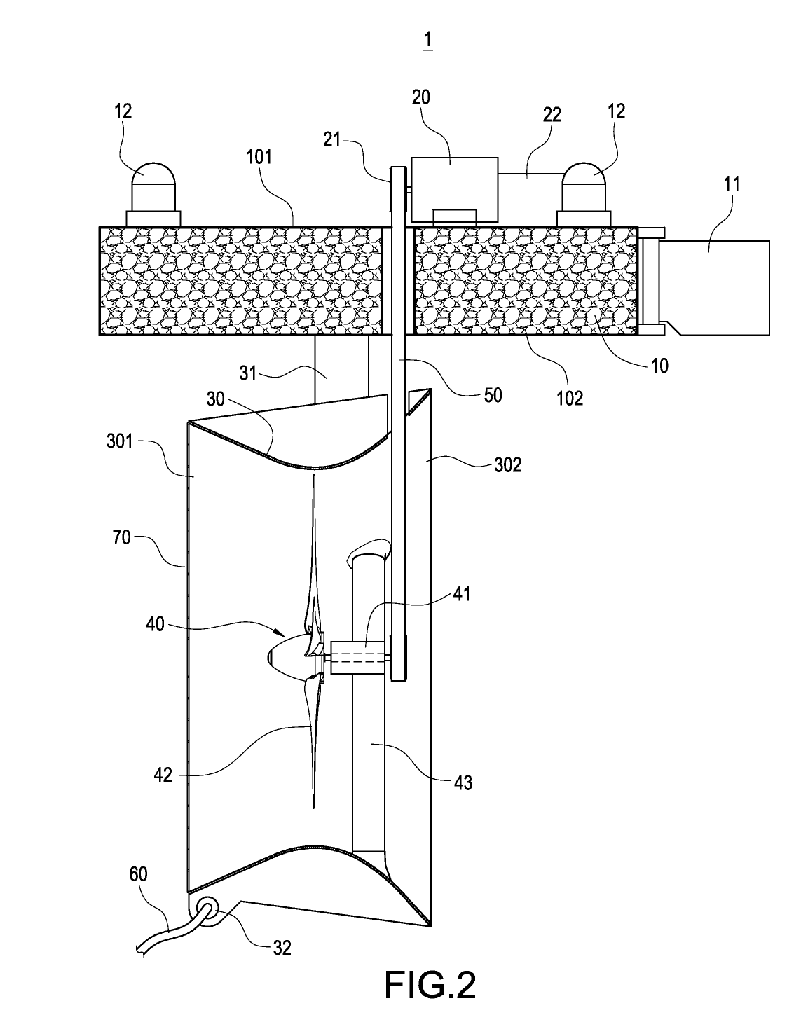

With reference to FIGS. 1 and 2 for a perspective view and a side view of a run-of-water hydroelectric power generation apparatus in accordance with the present invention respectively, the run-of-water hydroelectric power generation apparatus 1 comprises a buoy 10, an electric generator 20 installed at a top surface of the buoy 10, a case 30 installed at a bottom surface of the buoy 10, and a vane wheel 40.

The buoy 10 has a buoyancy for floating on a water surface of a flowing water current, and an electric generator 20 is installed at a top surface 101 of the buoy 10 and includes a rotating shaft 21, and the rotating shaft 21 includes a pulley or a gear installed thereon, and a warning lamp 12 is also installed at the top surface 11 of the buoy 10 and connected to the electric generator 20 for alerting a breakdown of the electric generator 20. In addition, the electric generator 20 includes an electric storage battery 22 for storing electric energy, and the buoy 10 includes a rudder 11 installed on a side of the buoy 10 for enhancing the balance of the buoy 10 when the buoy 10 is flowing on the water surface.

The case 30 is a hollow case having a board 31 installed on a side of the case 30 and connected to a bottom surface 102 of buoy 10, and a water entry end 301 and a water exit end 302 disposed on both ends of case 30 respectively, and tapered from both ends to the center of the case 30, such that the water entry end 301 and the water exit end 302 are in an expanded opening shape, and both water entry and exit ends 301, 302 in the expanded opening shape form a water current passage, such that the water current entering the convergent water entry end 301 will expedite the speed of the water current to increase the kinetic energy and pressure of the vanes. When the water current flows out from the divergent water exit end 302, the water exit speed and the pressure at the backside of the vanes are reduced to increase the pressure difference between the front and the back of the vanes, so as to produce greater torque and output power. The vane wheel 40 includes a wheel shaft 41 installed in the case 30, and a plurality of vanes 42 installed on a side of the vane wheel 40, wherein the wheel shaft 41 is coupled to a fixed stand 43, and the fixed stand 43 is coupled to an internal wall of the case 30, such that the vane wheel 40 can be fixed in the case 30.

In addition, the case 30 includes a protective net 70 installed at an end where the water current is entered, and the protective net 70 is provided for preventing external objects including fishes from entering together with the water current into the case 30.

An end of the transmission belt 50 is mounted onto the rotating shaft 21 of the electric generator 20, and another end of the transmission belt 50 is mounted onto the wheel shaft 41 of the vane wheel 40. By the transmission of the transmission belt 50, the rotation of the wheel shaft 41 of the vane wheel 40 drives the rotating shaft 21 of the electric generator 20 to rotate accordingly, wherein the transmission belt 50 is a belt or a chain, and the rotating shaft 21 and the wheel shaft 41 include a pulley or a gear installed thereon for facilitating the transmission of the transmission belt 50 installed between the rotating shaft 21 and the wheel shaft 41.

In addition, the case 30 further includes a hook ring 32 formed on another side and provided for passing an anchor device 60, wherein the anchor device 60 is a cable, a rope or a chain, and the anchor device 60 is installed at a bottom side of the buoy 10 and anchored to the bottom of a river for fixing the run-of-water hydroelectric power generation apparatus 1 into its position.

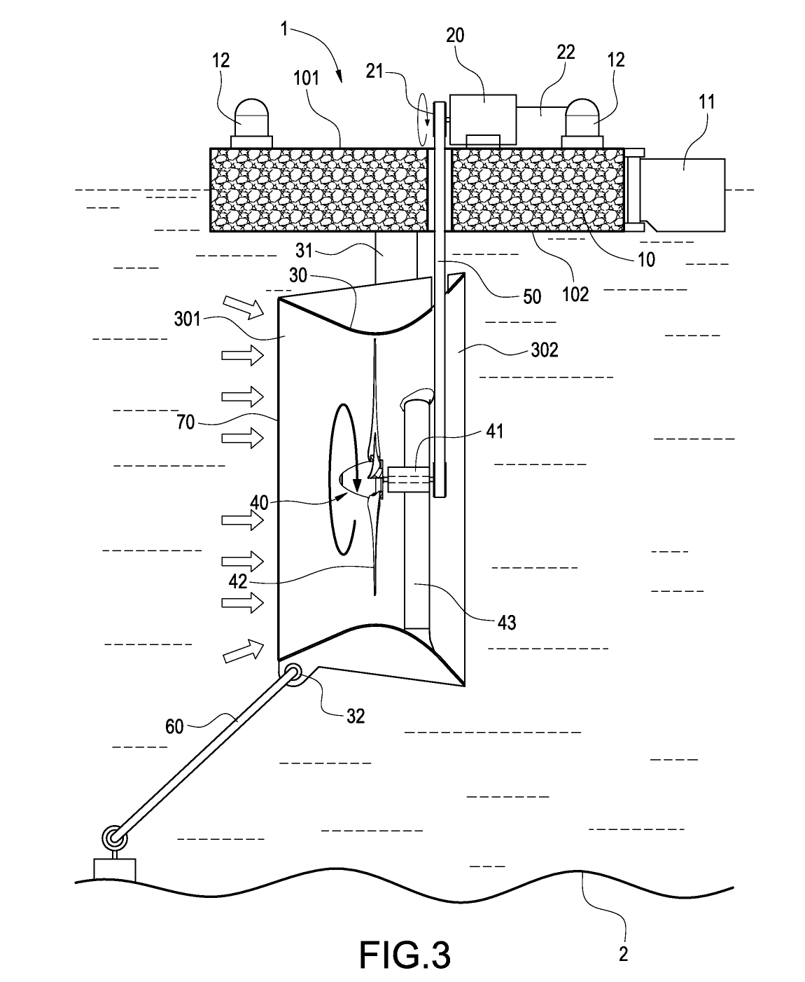

With reference to FIG. 3 for a schematic view of using a run-of-water hydroelectric power generation apparatus in accordance with the present invention, the run-of-water hydroelectric power generation apparatus 1 is installed at the position of a river 2 having a water current, and the buoy 10 floats on a water surface of the river 2, and the electric generator 20 disposed on the buoy 10 is not in contact with the water surface, and the case 30 and the vane wheel 40 are anchored by the anchor device 60 and fixed under the water surface, such that if the water current passes through the vane wheel 40, the vanes 42 will be rotated to drive the wheel shaft 41 to rotate accordingly. Finally, the transmission of the transmission belt 50 can drive the rotating shaft 21 of the electric generator 20 to rotate, so as to generate electric energy.

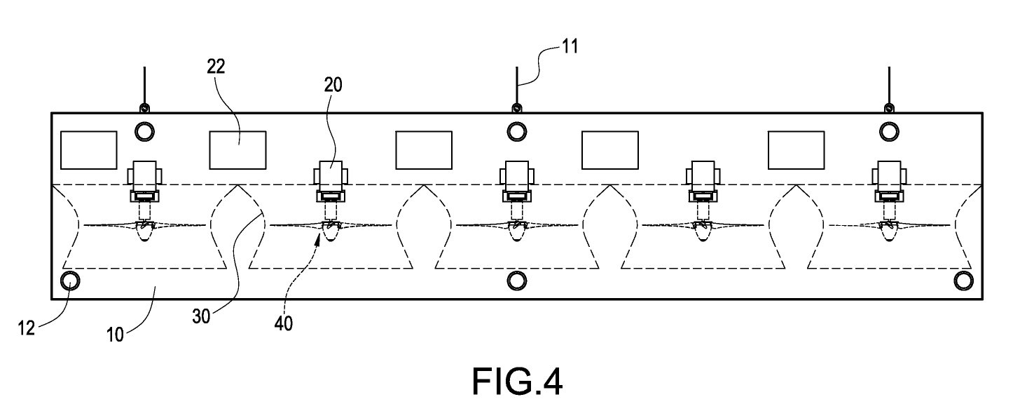

With reference to FIG. 4 for a schematic view of an application of a run-of-water hydroelectric power generation apparatus in accordance with the present invention, the buoy 10 includes a plurality of vane wheels 40 installed at a bottom surface of the buoy 10, a plurality of electric generators 20 installed in parallel with each other and on a top surface of the buoy 10 for collecting the electric energy generated by the electric generators 20 or storing the electric energy of each electric storage battery 22 to provide a larger power supply.

While the invention has been described by means of specific embodiments, numerous modifications and variations could be made thereto by those skilled in the art without departing from the scope and spirit of the invention set forth in the claims.

What is claimed is:

1. A run-of-water hydroelectric power generation apparatus, applied to a river with a water current, and comprising:
a buoy, having a buoyancy, and floating on a water surface of the river;
an electric generator, including a rotating shaft, and installed at a top surface of the buoy;
a case, being a hollow case, with both ends tapered towards the center of the case to form an expanded opening shape, and a side of the case being coupled to a bottom surface of the buoy;
a vane wheel, installed in the case, and including a wheel shaft, and a plurality of vanes disposed on a side of the wheel shaft; and
a transmission belt, installed around the wheel shaft and the rotating shaft, for providing a transmission between the wheel shaft and the rotating shaft.

2. The run-of-water hydroelectric power generation apparatus of claim 1, wherein the buoy further includes a warning lamp installed at the top surface of the buoy and electrically coupled to the electric generator for alerting a breakdown of the electric generator.

3. The run-of-water hydroelectric power generation apparatus of claim 1, wherein the buoy further includes a rudder installed on a side of the buoy for balancing the buoy.

4. The run-of-water hydroelectric power generation apparatus of claim 1, wherein the electric generator further includes an electric storage battery for storing an electric energy.

5. The run-of-water hydroelectric power generation apparatus of claim 1, wherein the case includes a board disposed on a side of the case for connecting the case to the bottom surface of the buoy.

6. The run-of-water hydroelectric power generation apparatus of claim 1, further comprising a fixed stand coupled to another side of the wheel shaft, and the fixed stand being also coupled to an internal wall of the case for fixing the wheel shaft.

7. The run-of-water hydroelectric power generation apparatus of claim 1, wherein the transmission belt is a belt.

8. The run-of-water hydroelectric power generation apparatus of claim 1, wherein the transmission belt is a chain.

9. The run-of-water hydroelectric power generation apparatus of claim 1, further comprising an anchor device installed at a bottom surface of the buoy for anchoring the bottom of the river.

10. The run-of-water hydroelectric power generation apparatus of claim 9, wherein the anchor device is installed to the case for anchoring the bottom of the river.

11. The run-of-water hydroelectric power generation apparatus of claim 9, wherein the case includes a hook ring for passing the anchor device.

12. The run-of-water hydroelectric power generation apparatus of claim 9, wherein the anchor device is a cable.

13. The run-of-water hydroelectric power generation apparatus of claim 1, further comprising a protective net installed at an end of the case where the water current is entered.
